(19) United States
(12) Patent Application Publication
(10) Pub. No.: US 2011/0228177 A1
(43) Pub. Date: Sep. 22, 2011

(54) LIQUID CRYSTAL DEVICE AND PROJECTION DISPLAY DEVICE

(75) Inventors: Naofumi FUKUDA, Shiojiri-shi (JP); Akihide HARUYAMA, Suwa-shi (JP)

(73) Assignee: SEIKO EPSON CORPORATION, Tokyo (JP)

(21) Appl. No.: 13/040,239

(22) Filed: Mar. 3, 2011

(30) Foreign Application Priority Data
Mar. 18, 2010 (JP) 2010-062093

(51) Int. Cl. G02F 1/1335

(52) U.S. Cl. 349/5; 349/96; 349/114

(57) ABSTRACT

A liquid crystal device including a liquid crystal panel where a liquid crystal layer having liquid crystals with negative dielectric constant anisotropy is interposed between a first substrate and a second substrate, liquid crystal molecules are tilted in a predetermined direction with regard to an inner surface of the first substrate and an inner surface of the second substrate, and a reflective layer reflects light incident, is provided in the second substrate; a C plate provided on an outer side of the first substrate; and an O plate provided on the C plate side opposite to the liquid crystal panel. The O plate is formed by oblique evaporation of an inorganic material and is arranged with regard to the liquid crystal panel so that the tilt direction of columns formed from the inorganic material is typically at 135 degrees with regard to the tilt direction of the liquid crystal molecules.

### BACKGROUND

1. Technical Field

The present invention relates to a liquid crystal device and a projection display device.

2. Related Art

In recent years, VA (Vertical Alignment) mode liquid crystal devices have attracted attention as being superior in contrast when viewed from the front. The VA mode liquid crystal devices are provided with a liquid crystal layer where liquid crystal molecules are aligned substantially vertically between a pair of substrates.

However, in a case of viewing from a diagonal direction, there is a decline in contrast and display characteristics deteriorate even with such VA mode liquid crystal devices.

Therefore, in the related art, compensation of the phase difference of light which passes diagonally through the liquid crystal layer is performed using a phase difference compensation element, a so-called C plate, with a unique vertical optical axis in regard to the element surface. At this time, the front phase difference of the liquid crystal is compensated for by the C plate by tilting the C plate so that the optical axis of the C plate is parallel to the pretilt direction of the liquid crystal molecules. In addition, a configuration such as this is applicable to not only a transmissive type but also a reflective type liquid crystal device.

In the liquid crystal device which uses the tilted C plate in this manner, a fixture for tilting the C plate is necessary.

However, in a case when positional deviation (tilting deviation) of the tilting fixture or orientation deviation of the liquid crystal alignment is generated, it is not possible to perform sufficient phase difference compensation by just tilting the C plate. Additionally, when variation in cell thickness of the liquid crystal panel is generated, it is necessary to adjust the front phase difference of the liquid crystal panel with cell thickness variation using the tilting angle of the C plate. However, in this case, the effective Rth of the C plate deviates from the optimal condition, and as compensation, the adjustment is not sufficient. Furthermore, along with an increase in the pretilt angle of the liquid crystal molecules, the tilting angle of the C plate also increases. However, at this time, a difference in the reflectivity of the P polarized light and S polarized light with regard to incident polarized light is generated, and due to the deviation of the axis of the incident polarized light, the contrast declines.

Therefore, it is proposed that an O plate added to the C plate such as this is used, larger phase difference compensation is performed and the contrast is increased (for. example, JP-A-2009-37025 and JP-A-2008-164754).

However, even in the liquid crystal device where the O plate is also used in this manner, since the C plate is used by tilting, in the case when the positional deviation (tilting deviation) of the tilting fixture or the orientation deviation of the liquid crystal alignment is generated as described above, and further, in a case when the cell gap or pretilt deviates from the set value, there is a problem in that a sufficient compensation effect is not obtained and it is not possible to achieve high contrast.

### SUMMARY

An advantage of some aspects of the invention is that a liquid crystal device and a projection display device provided with the liquid crystal device are provided where it is possible to obtain a sufficient compensation effect and to achieve high contrast without tilting the C plate.

A liquid crystal device according to an aspect of the invention has a liquid crystal panel where a liquid crystal layer having liquid crystals with negative dielectric constant anisotropy is interposed between a first substrate and a second substrate, liquid crystal molecules of the liquid crystal layer are tilted in a predetermined direction with regard to an inner surface of the first substrate and an inner surface of the second substrate, and a reflective layer, which reflects light incident from the first substrate to the first substrate side, is provided in the second substrate, a C plate provided on an outer side of the first substrate of the liquid crystal panel, and an O plate provided on the C plate side opposite to the liquid crystal panel, where the O plate is formed by oblique evaporation of an inorganic material and is arranged with regard to the liquid crystal panel so that the tilt direction of columns formed from the inorganic material are typically at 135 degrees in a clockwise direction with regard to the tilt direction of the liquid crystal molecules.

According to the liquid crystal device of the aspect, it is possible to have the C plate face the liquid crystal panel without tilting the C plate, and furthermore, it is possible to achieve high contrast as will be made clear from the results of experiments described later.

A liquid crystal device according to another aspect of the invention has a liquid crystal panel where a liquid crystal layer having liquid crystals with negative dielectric constant anisotropy is interposed between a first substrate and a second substrate, liquid crystal molecules of the liquid crystal layer are tilted in a predetermined direction with regard to an inner surface of the first substrate and an inner surface of the second substrate, and a reflective layer, which reflects light incident from the first substrate to the first substrate side, is provided in the second substrate, an O plate provided on an outer side of the first substrate of the liquid crystal panel, and a C plate provided on the O plate opposite to the liquid crystal panel, where the O plate is formed by oblique evaporation of an inorganic material and is arranged with regard to the liquid crystal panel so that the tilt direction of columns formed from the inorganic material are typically at 45 degrees in a counterclockwise direction with regard to the tilt direction of the liquid crystal molecules.

According to the liquid crystal device of the other aspect, it is possible to have the C plate face the liquid crystal panel without tilting the C plate, and furthermore, it is possible to achieve high contrast as will be made clear from the results of experiments described later.

Additionally, in the liquid crystal device, it is preferable if the O plate has a front phase difference Re equal to or less than 20 nm and a phase difference ratio is more than 1 and equal to or less than 3, and the C plate has a thickness-direction phase difference Rth equal to or more than 100 nm and equal to or less than 300 nm.

Furthermore, it is preferable if the O plate has a front phase difference Re of 10 nm and a phase difference ratio of 2, and the C plate has a thickness-direction phase difference Rth of 240 nm.

Additionally, in the liquid crystal device, it is preferable if a polarization beam splitter is provided on a side of the C plate and the O plate opposite to the liquid crystal panel, and the transmission axis of the polarization beam splitter is arranged with regard to the liquid crystal panel so as to be typically 45 degrees or 135 degrees with regard to a slow axis of the liquid crystal molecules.

In this manner, the phase difference compensation with in-plane rotation is performed even for the polarization beam splitter with regard to light reflected by the liquid crystal panel.

A projection display device according to an aspect of the invention is provided with the liquid crystal device as a light modulator.

According to the projection display device of the aspect, since it is provided with the liquid crystal device which is able to achieve high contrast as a light modulator as described above, it is possible to achieve high contrast also in the projection display device itself.

### BRIEF DESCRIPTION OF THE DRAWINGS

The invention will be described with reference to the accompanying drawings, wherein like numbers reference like elements.

FIG. 1 is a perspective diagram illustrating a schematic configuration of a liquid crystal projector according to the invention.

FIG. 2 is a diagram illustrating a schematic configuration of an image formation system.

FIGS. 3A and 3B are pattern diagrams for describing a schematic configuration of a reflective light modulating device.

FIG. 4 is a diagram illustrating a relationship of a tilt direction of liquid crystal molecules and a tilt direction of columns of an O plate.

FIGS. 5A to 5C are side views illustrating a schematic configuration of a phase difference compensation plate.

FIGS. 6A and 6B are pattern diagrams for describing optical anisotropy of each plate.

FIG. 7 is a pattern diagram for describing a microscopic structure of the O plate.

FIG. 8 is a graph illustrating an actual contrast measurement result of an experiment example 1.

FIG. 9 is a graph illustrating an actual contrast measurement result of an experiment example 2.

FIG. 10 is a pattern diagram illustrating an arrangement relationship of a liquid crystal panel and the phase difference compensation plate.

FIG. 11 is a graph illustrating an actual contrast measurement result of an experiment example 3.

FIG. 12 is a graph illustrating an actual contrast measurement result of the experiment example 3.

FIG. 13 is a graph illustrating an actual contrast measurement result of an experiment example 4.

### DESCRIPTION OF EXEMPLARY EMBODIMENTS

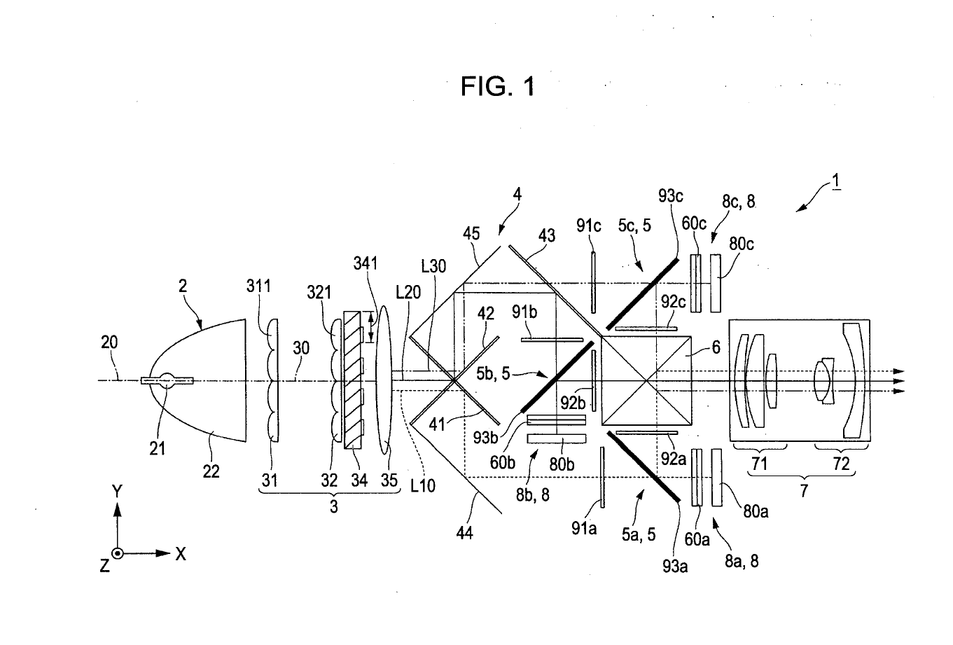

Below, a liquid crystal device according to the invention and a projection display device provided with the liquid crystal device will be described with reference to the diagrams. FIG. 1 is a pattern diagram illustrating a schematic configuration of a liquid crystal projector 1 which is an example of the projection display device provided with the liquid crystal device according to the invention as a light modulator.

The liquid crystal projector 1 has a light source device 2, an integrator optical system 3, a color separator optical system 4, a 3-system image formation system 5, a color synthesizing element 6, and a projection optical system 7. The 3-system image formation system 5 is provided with a first image formation system 5a, a second image formation system 5b and a third image formation system 5c.

A light flux exiting from the light source device 2 is incident on the integrator optical system 3. The light fluxes incident on the integrator optical system 3 are made to have uniform illuminance and have the same polarization state. The light fluxes exiting from the integrator optical system 3 are separated into a plurality of color light fluxes by the color separator optical system 4 and are incident on the image formation system 5 with a different system for each color light flux. The color light fluxes incident on each of the 3 systems of the image formation system 5 are modulated based on image data on the image to be displayed and become modulated light. The three colors of modulated light fluxes exiting from the 3-system image formation system 5 are synthesized by the color synthesizing element 6 and become multicolor light fluxes and are incident on the projection optical system 7 which includes a first lens section 71 and a second lens section 72. Then, the light fluxes are projected onto a projection surface (not shown) such as a screen. According to this, a full-color image is displayed on the projection surface.

Next, constituent elements of the projector 1 will be described in detail.

The light source device 2 has a light source lamp 21 and a paraboloidal reflector 22. The light emitted from the light source lamp 21 is reflected in one direction by the paraboloidal reflector 22, becomes substantially parallel light fluxes and is incident on the integrator optical system 3. The light source lamp 21 is configured by, for example, a metal. halide lamp, a xenon lamp, a high-pressure mercury lamp, or a halogen lamp. Additionally, the reflector may be configured by an ellipsoidal reflector, a spherical reflector or the like instead of the paraboloidal reflector 22. A parallelizing lens which makes light exiting from the reflector parallel may be used according to the shape of the reflector.

The integrator optical system 3 has a first lens array 31, a second lens array 32, a polarization modulation element 34, and a superimposing lens 35. An optical axis 30 of the integrator optical system 3 substantially matches an optical axis 20 of the light source device 2, and each of the constituent elements of the integrator optical system 3 is arranged so that a central position is lined up on the optical axis 30 of the integrator optical system 3.

The first lens array 31 has a plurality of lens elements 311 which are arranged in line in a plane which is substantially perpendicular to the optical axis 20 of the light source device 2. The second lens array 32 has a plurality of lens elements 321 in a similar manner to the lens elements 311. The lens array 311 and 321 are, for example, arranged in line in a matrix shape.

The polarization modulation element 34 has a plurality of polarization modulator units 341. A detailed configuration of the polarization modulator units 341 is not diagrammatically shown, but the polarization modulator units 341 are configured by having a polarization beam splitter film (referred to below as a PBS film), a ½ phase plate, and a reflective mirror.

The lens elements 311 of the first lens array 31 correspond one-to-one with the lens elements 321 of the second lens array 32, and the lens elements 321 of the second lens array 32 correspond one-to-one with the polarization modulator units 341 of the polarization modulation element 34. The lens elements 311, the lens elements 321, and the polarization modulator units 341 which are in a corresponding relationship with each other are lined up and arranged along an axis substantially parallel to the optical axis 30.

The light fluxes incident on the integrator optical system 3 are spatially separated by and incident on the plurality of lens elements 311 of the first lens array 31 and are focused into a light flux incident on the respective lens elements 311. The light fluxes focused by the lens elements 311 are imaged by the lens elements 321 corresponding to the lens elements 311. That is, a two dimensional light source image is formed for each of the plurality of lens elements 321 of the second lens array 32. The light fluxes from the two dimensional light source image formed by the lens elements 321 are incident on the polarization modulator units 341 corresponding to the lens elements 321.

The light fluxes incident on the polarization modulator units 341 are separated into P polarized light fluxes and S polarized light fluxes with regard to the PBS film. One of the separated polarized light fluxes passes through the ½ phase plate after being reflected by the reflective mirror and the polarization state thereof is made the same as the other polarized light flux. Here, the polarization states of the light fluxes which have passed through the polarization modulator units 341 are all made to be P polarized light fluxes. The light fluxes exiting from each of the plurality of polarization modulator units 341 are refracted by being incident on the superimposing lens 35 and are superimposed on an illumination region of a reflective light modulation device (light modulator) 8.

Each of the plurality of light fluxes spatially separated by the first lens array 31 in this manner is made so that the illumination distribution is uniform in the plurality of light fluxes by illuminating substantially the entire region of the illumination region and the illumination of the illumination region is made to be uniform.

Here, the reflective light modulation device 8 configures an embodiment of the liquid crystal device of the invention and is configured by being provided with a liquid crystal panel 80 and a phase difference compensation plate 60 (60a, 60b and 60c) arranged in front of the liquid crystal panel 80. In addition, the reflective light modulation device 8 (liquid crystal device) will be described in detail later.

The color separator optical system 4 is configured by having first to third dichroic mirrors 41 to 43 with wavelength-selecting surfaces and first and second reflective mirrors 44 and 45. The first dichroic mirror 41 has a characteristic of reflecting red light fluxes and transmitting green light fluxes and blue light fluxes. The second dichroic mirror 42 has a characteristic of transmitting red light fluxes and reflecting green light fluxes and blue light fluxes. The third dichroic mirror 43 has a characteristic of reflecting green light fluxes and transmitting blue light fluxes. The first and second dichroic mirrors 41 and 42 are arranged so that each of the wavelength selecting surfaces are substantially at a 45 degree angle to the optical axis 30 of the integrator optical system 3 so that each of the wavelength selecting surfaces are substantially perpendicular to each other.

A red light flux L10, a green light flux L20, and a blue light flux L30 which are included in the light fluxes incident on the color separator optical system 4 are separated as per below and are incident on the image formation system 5 corresponding to each of the separated color light fluxes. After being transmitted by the second dichroic mirror 42 and reflected by the first dichroic mirror 41, the light flux L10 is reflected by the first reflective mirror 44 and is incident on the first image formation system 5a. After being transmitted by the first dichroic mirror 41 and reflected by the second dichroic mirror 42, the light flux L20 is reflected by the second reflective mirror 45, is next reflected by the third dichroic mirror 43, and is incident on the second image formation system 5b. After being transmitted by the first dichroic mirror 41 and reflected by the second dichroic mirror 42, the light flux L30 is reflected by the second reflective mirror 45, is next transmitted by the third dichroic mirror 43, and is incident on the third image formation system 5c.

The first to third image formation systems 5a to 5c have the same configuration. Here, a configuration of the first image formation system 5a is described as a representative of the first to third image formation systems 5a to 5c.

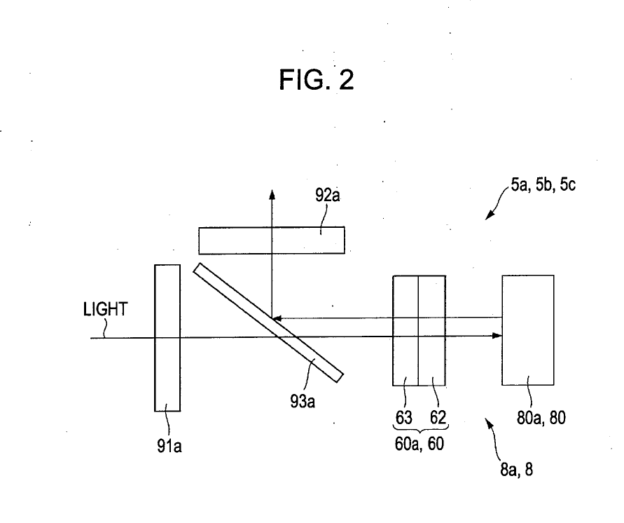

FIG. 2 is a diagram illustrating a schematic configuration of the first image formation system 5a. As shown in FIG. 2, the first image formation system 5a is configured by having an incidence-side polarization plate 91a, a wire grid polarization beam splitter (referred to below as WG-PBS) 93a, a phase difference compensation plate 60a (60), a liquid crystal panel 80a (80), and an exiting-side polarization plate (polarization detector) 92a. A reflective light modulation device 8a (8) is formed by the phase difference compensation plate 60a (60) and the liquid crystal panel 80a (80), and according to this, an embodiment of the liquid crystal device of the invention is configured. Additionally, another embodiment of the liquid crystal device of the invention is configured by an embodiment where the WG-PBS (wire grid polarization beam splitter) 93a is added to the reflective light modulation device 8a (8).

The red light flux L10, which is a portion of the light flux exiting from the color separator optical system 4 as shown in FIG. 1, is irradiated on the incidence-side polarization plate 91a. The incidence-side polarization plate 91a allows straight polarized light to pass and the transmission axis thereof is set so that P polarized light fluxes pass through the polarized light separating surface of the WG-PBS 93a. Below, the P polarized light fluxes with regard to the polarized light separating surface of the WG-PBS 93a are simply referred to as P polarized light fluxes, and the S polarized light fluxes with regard to the polarized light separating surface of the WG-PBS 93a are simply referred to as S polarized light fluxes. As described previously, the light fluxes which pass through the integrator optical system 3 are made to have the polarization state of the P polarized light fluxes, and most of the light flux L10 passes through the incidence-side polarization plate 91a and is incident on the WG-PBS 93a.

Here, the WG-PBS 93a is arranged with regard to the liquid crystal panel 80a so that the transmission axis thereof typically intersects at an angle of 45 degrees or 135 degrees with regard to the liquid crystal layer of the slow axis of the liquid crystal panel 80a described later. In addition, these angles are one and the other angles of adjacent angles formed by two straight lines crossing, and accordingly, have a meaning that is actually the same relationship.

Additionally, the typical 45 degrees or 135 degrees have a meaning of a range of 45 degrees±10%, that is, 40.5 degrees or more and 49.5 degrees or less, and a range of 135 degrees±10%, that is, 121.5 degrees or more and 148.5 degrees or less. Even if there is deviation within the 10% range with regard to the predetermined angle arrangement such as this, the WG-PBS 93a performs excellent phase difference compensation with in-plane rotation with regard to light reflected by the liquid crystal panel 80a.

Out of the light flux L10 incident on the polarized light separating surface of the WG-PBS 93a, the S polarized light fluxes where the polarization direction is a reflective axis direction is reflected by the polarized light separating surface and the P polarized light fluxes where the polarization direction is the transmission axis direction pass through the polarized light separating surface. The light flux L10 exiting from the integrator optical system 3 typically becomes a P polarized light flux, passes through the polarized light separating surface, and is incident on the reflective light modulation device 8a. The light flux L10 incident on the reflective light modulation device 8a passes through the phase difference compensation plate 60a, and after being modulated by the liquid crystal panel 80a, is reflected and incident again on the phase difference compensation. plate 60a.

After optical compensation is performed by the phase difference compensation plate 60a, the light flux L10 (modulated light) incident on the phase difference compensation plate 60a is incident again on the WG-PBS 93a. Then, the light flux L10 where the polarization state has been changed is reflected by the WG-PBS 93a, is selectively passed through the exiting-side polarization plate 92a, and is incident on the color synthesizing element 6. In the same manner, after optical compensation is performed, each of the green light flux L20 and the blue light flux L30 also are incident on the color synthesizing element 6.

Then, the light incident on the color synthesizing element 6 is synthesized here and becomes multicolor light fluxes, is incident on the projection optical system 7 as described previously, and furthermore, is projected onto a projection surface (not shown) such as a screen.

Next, the liquid crystal panel 80 (80a, 80b and 80d) and the phase difference compensation plate 60 (60a, 60b and 60c) which configure the reflective light modulation device 8 (8a, 8b and 8c) will be described in detail.

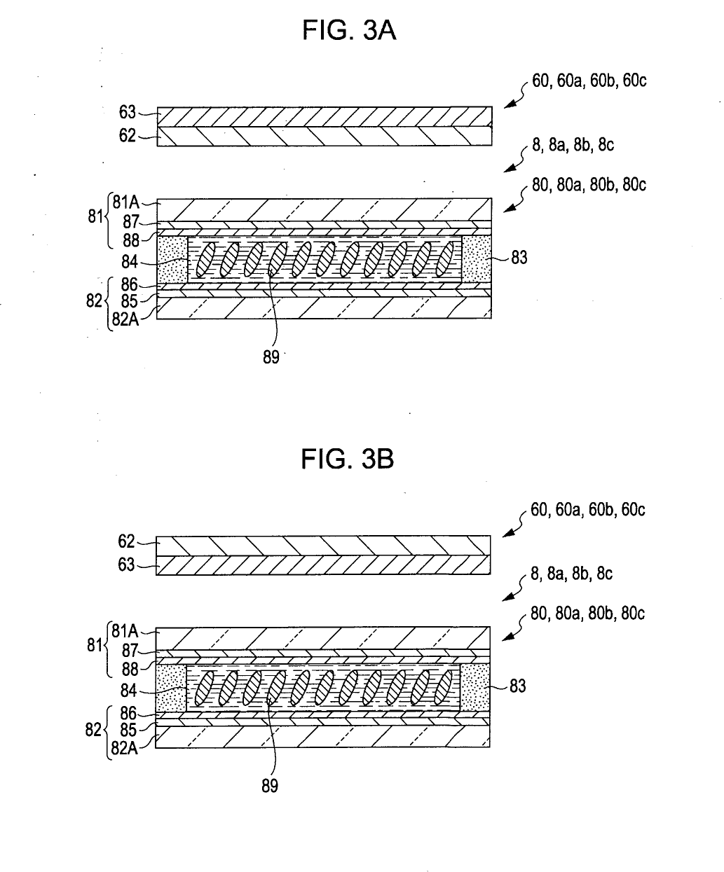

As shown in FIGS. 3A and 3B, the liquid crystal panel 80 is a reflective VA mode where an opposing substrate (first substrate) 81 and a TFT substrate (second substrate) 82 are bonded together by a seal member 83 and a liquid crystal layer 84 is interposed and enclosed between the substrates 81 and 82.

The TFT substrate 82 has gate lines (not shown) and source lines (not shown) arranged on a glass substrate 82A in a crisscrossing manner and pixel electrodes (reflective layer) 85 are formed via a thin film transistor (TFT) (not shown) at the intersecting portions. The pixel electrodes 85 are metallic with a specular reflection layer and Al, Ag or an alloy thereof is appropriately used. Additionally, an orientated film 86 is provided on the pixel electrode 85. In addition, an insulating layer may be provided between the pixel electrode 85 and the orientated film 86 in order to prevent flicker and burn-in.

In the opposing substrate 81, a common electrode (transparent electrode) 87 is provided formed from ITO on a glass substrate 81A, and furthermore, an orientated film 88 is provided on the common electrode 87.

The orientated films 86 and 88 are formed in the embodiment by SiO₂ being obliquely evaporated by a vacuum evaporation method. Specifically, the orientated films 86 and 88 are formed in the conditions where the degree of vacuum is 5×10⁻³ Pa and the substrate temperature is 100° C. when beginning the evaporation. In regard to the oblique evaporation, the columns of the SiO₂ are grown in a direction tilted by 70 degrees to the same orientation as the evaporation by performing the evaporation from a direction tilted by 45 degrees from the substrate surface, and according to this, anisotropy is applied to the orientated films 86 and 88. In addition, in the opposing substrate 81 side of the orientated film 88 and the TFT substrate 82 side of the orientated film 86, it is set so that the tilt direction of the respective columns are not parallel.

The opposing substrate 81 and the TFT substrate 82 are held and bonded together with a gap of, for example, 1.8 μm, and a liquid crystal cell is formed by injecting liquid crystals with negative dielectric constant anisotropy (Δn=0.12) therebetween. Liquid crystal molecules 89 are arranged between the orientated films 86 and 88 so as to be tilted by 85 degrees from the substrate surface in the same direction as the tilt direction of the columns of the orientated films 86 and 88, that is, the pretilt angle θp, is 85 degrees. By applying a pretilt angle in this manner, the liquid crystal molecules 89 have an optical anisotropy and the liquid crystal layer 88 formed from the liquid crystal molecules 89 has a slow axis.

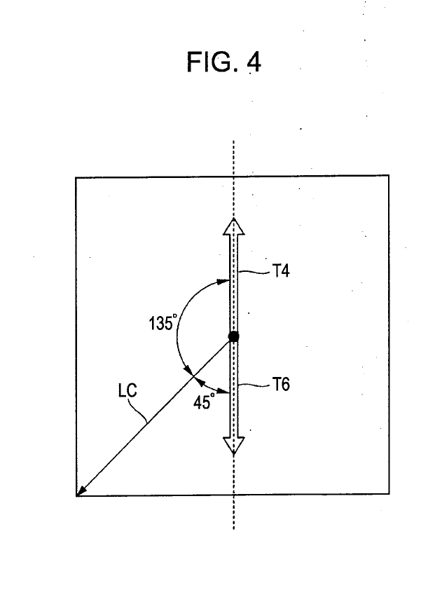

The slow axis of the liquid crystal layer 88 matches the length direction of the length axis of the liquid crystal molecules 89 with an ellipsoid shape which are projected onto the opposing substrate 81 or the. TFT substrate 82 when viewing the liquid crystal molecules 89 from the normal line direction of the opposing substrate 81 and the TFT substrate 82. Additionally, in regard to one end side of the length axis, the other end side of the liquid crystal molecules 89 is tilted due to the applied pretilt angle. The tilt direction, that is, the direction tilted from the normal line of the TFT substrate 82 from the TFT substrate 82 side toward the opposing substrate 81 side, becomes a tilt direction in the embodiment from the center of the liquid crystal panel 80 toward the lower left side as shown by the arrow LC in FIG. 4. That is, a 45 degree (135 degree) tilt with regard to the polarization axis (shown in FIG. 4 by a dashed line) of the polarization plate arranged on an outer side of the opposing substrate 81 of the liquid crystal panel 80.

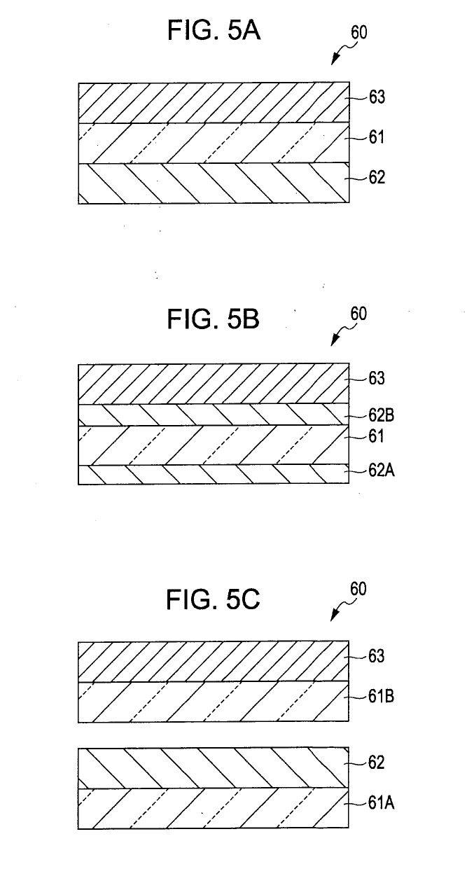

As shown in FIG. 3A, the phase difference compensation plate 60 is arranged on an outer side of the opposing substrate 81 of the liquid crystal panel 80, that is, in front of the liquid crystal panel 80. In the embodiment, as shown in FIG. 5A, the phase difference compensation plate 60 is formed by a C plate (negative C plate) 62 being formed on one surface of a substrate 61 formed from quartz glass, and on the other surface, by an O plate 63 being formed. Then, in the embodiment, the phase difference compensation plate 60 formed with such a configuration is set so that the C plate 62 is positioned on the liquid crystal panel 80 side and the O plate 63 is positioned on the C plate 62 side opposite to the liquid crystal panel 80, and is positioned in parallel with the liquid crystal panel 80 in front of the liquid crystal panel 80.

The C plate 62 is a single axial double refraction index body formed from a multilayer film formed by alternatively laminating a high refraction index layer and a low refraction index layer on the substrate 61 by a sputtering method or the like. The C plate 62 has a vertical optical axis with regard to the surface of the C plate 62 and compensates the phase difference of the tilted light exiting from the liquid crystal panel 80. In addition, the high refraction index layer is formed from, for example, TiO₂ or ZrO₂ which are dielectrics with a high refraction index, and the low refraction index layer is formed from, for example, SiO₂ or MgF₂ which are dielectrics with a low refraction index. It is preferable that the thickness of each of the refraction index layers of the C plate 62 formed with such a configuration is thin so as to prevent light which passes through from being reflected at each layer and causing interference.

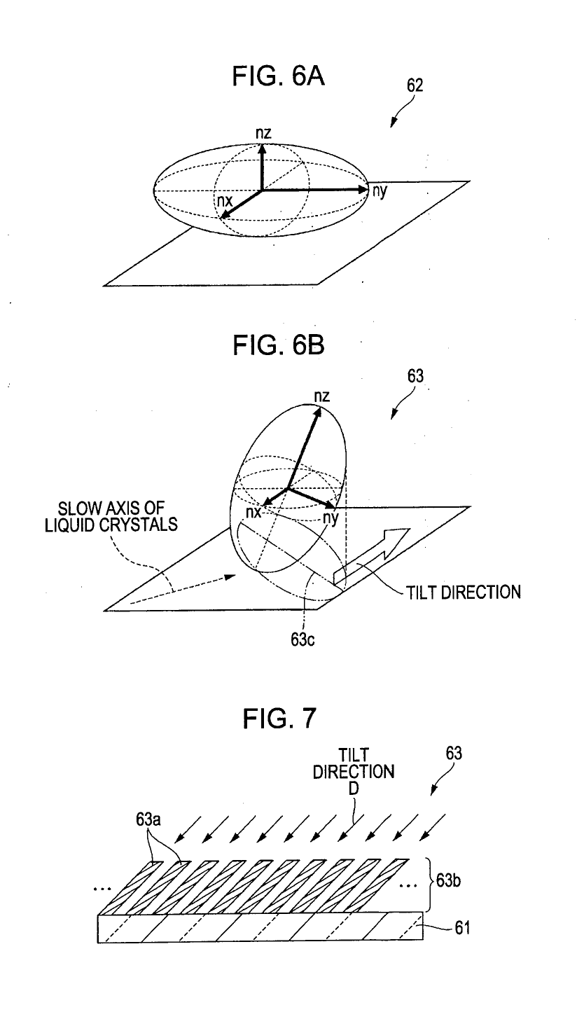

FIG. 6A is a pattern diagram for describing the optical anisotropy of the C plate 62. As shown in FIG. 6A, the C plate is nx=ny>nz, and accordingly, it is not possible to compensate for phase difference since the light incident in a parallel manner on the optical axis with regard to the C plate is isotropic. That is, with regard to the light which is vertically incident from the liquid crystal panel 80 onto the C plate 62, it is not possible to compensate for phase difference. On the other hand, out of the light exiting from the liquid crystal panel 80, the tilted components of light, that is, the tilted components of the VA mode liquid crystals, are set to optically compensate for phase difference. In addition, in regard to the C plate 62, there may be a slight phase difference without nx=ny being completely satisfied. Specifically, the front phase difference may be approximately from 0 to 3 nm.

As the C plate 62 such as this, it is preferable if the thickness-direction phase difference Rth is equal to or more than 100 nm and equal to or less than 300 nm, and more preferably, 240 nm. Here, the thickness-direction phase difference Rth is defined by the equation below.

Rth={(nx+ny)/2−nz}×d

Here, nx and ny represent principal refractive indices in a surface direction of the C plate shown in FIG. 6A, and nz represents a principal refractive index in the same thickness direction. Additionally, d represents the thickness of the C plate.

The O plate 63 is formed by oblique evaporation of an inorganic material such as Ta₂O₅ on the other surface of the substrate 61 formed from quartz glass as shown in FIG. 5A. The O plate 63 has a film structure having columns 63a which have grown in the inorganic material along a tilt direction D viewed microscopically as shown in FIG. 7. That is, an inorganic film (evaporation film) 63b of the O plate 63 has the columns (column-shaped portions) 63a which extend along the tilt direction D in which the inorganic material has been obliquely evaporated in a microscopic cross-section on the substrate 61. The inorganic film 63b formed with such a configuration generates phase difference to a greater or lesser extent caused by the microscopic structure thereof.

FIG. 6B is a pattern diagram for describing the optical anisotropy of the O plate 63. As shown in FIG. 6B, the O plate is a biaxial phase difference compensation plate where nx<ny<nz. The O plate 63 has a slow axis 63c due to the inorganic film 63b formed of the columns 63a.

The slow axis 63c of the O plate 63 matches the length direction of the length axis of the elliptical shape projected onto the substrate 61 (substrate surface) with the oval sphere shown in FIG. 6B viewed from the normal direction of the substrate 61. Additionally, the inorganic film 63b is formed with the columns 63a that form it being tilted. That is, with regard to one end side of the length axis (slow axis), the other end side of the columns 63a is tiled. The tilt direction, that is, the direction tilted from the normal line of the substrate. 61 from the substrate 61 side toward the opposite side, becomes a direction shown by the arrow T4 in FIG. 4 in the embodiment.

The direction shown by the arrow T4 is a position which is typically 135 degrees in a clockwise direction with regard to the tilt direction LC of the liquid crystal molecules 89. That is, in the embodiment, with regard to the liquid crystal panel 80, the phase difference compensation plate 60 is arranged so that the tilt direction T4 of the columns 63a of the O plate 63 is typically 135 degrees in a clockwise direction with regard to the tilt direction LC of the liquid crystal molecules 89 of the liquid crystal panel 80.

Here, the typical 135 degrees has a meaning of a range of 135 degrees±10%, that is, 121.5 degrees or more and 148.5 degrees or less. Even if there is deviation within the 10% range with regard to the 135 degrees, the O plate 63 (phase difference compensation plate 60) performs excellent phase difference compensation with in-plane rotation with regard to light reflected by the liquid crystal panel 80.

As the O plate 63 such as this, it is preferable if the front phase difference Re is equal to or less than 20 nm, and more preferable, is 10 nm. Additionally, it is preferable if the phase difference ratio is more than 1 and equal to or less than 3, and more preferably, is 2.

Here, the front phase difference Re is defined by the equation below.

Re=(nx−ny)×d

Here, nx and ny represent principal refractive indices in a surface direction of the O plate shown in FIG. 6B. Additionally, d represents the thickness of the O plate.

Additionally, the phase difference ratio is defined as the ratio {Re(30)/Re(−30)} which is a ratio of a phase difference Re(30) from a direction with a polar angle of 30 degrees and a phase difference Re(−30) from a direction with a polar angle of −30 degrees, with regard to the substrate 61. Re(30) is the tilt direction of the columns 63a of the O plate 63. The polar angle is the angle of the line of sight when the angle when looking from the front of the O plate 63 is 0 degrees.

Additionally, as the other embodiment of the phase difference compensation plate 60, as shown in FIG. 3B, the phase difference compensation plate 60 may be arranged in parallel with the liquid crystal panel 80 in front of the liquid crystal panel 80 so that the O plate 63 is positioned on the liquid crystal panel 80 side and the C plate 62 is positioned on the O plate 63 side opposite to the liquid crystal panel 80. That is, the phase difference compensation plate 60 shown in FIG. 5A may be arranged so that it faces the opposite direction with regard to the liquid crystal panel 80.

However, in this case, the tilt direction of the columns 63a of the O plate 63 is a direction shown by an arrow T6 in FIG. 4.

The direction shown by the arrow T6 is a position which is typically 45 degrees in a counterclockwise direction with regard to the tilt direction LC of the liquid crystal molecules 89. That is, in the embodiment, with regard to the liquid crystal panel 80, the phase difference compensation plate 60 is arranged so that the tilt direction of the columns 63a of the O plate 63 is typically 45 degrees in a counterclockwise direction with regard to the tilt direction LC of the liquid crystal molecules 89 of the liquid crystal panel 80.

Here, the typical 45 degrees has a meaning of a range of 45 degrees±10%, that is, 40.5 degrees or more and 49.5 degrees or less. Even if there is deviation within the 10% range with regard to the 45 degrees, the O plate 63 (phase difference compensation plate 60) performs excellent phase difference compensation with in-plane rotation with regard to the light reflected by the liquid crystal panel 80.

### EXPERIMENT EXAMPLE 1

With regard to the configuration of the reflective light modulation device 8 shown in FIG. 3A, the contrast was measured. Here, as the C plate 62 of the phase difference compensation plate 60, a C plate where 100 nm≦Rth≦300 nm was used, and as the O plate 63, an O plate where Re≦20 nm and 1<phase difference ratio≦3 was used. Additionally, the liquid crystal panel 80 had a cell gap of 1.8 μm and the pretilt angle of the liquid crystal molecules 89 was 85 degrees.

Additionally, for comparison, optical compensation was performed by using a phase difference compensation plate where the C plate is arranged to be tilted with regard to the liquid crystal panel 80. In addition, as the C plate, a C plate where Rth=240 nm is used as optimal with regard to the liquid crystal panel 80.

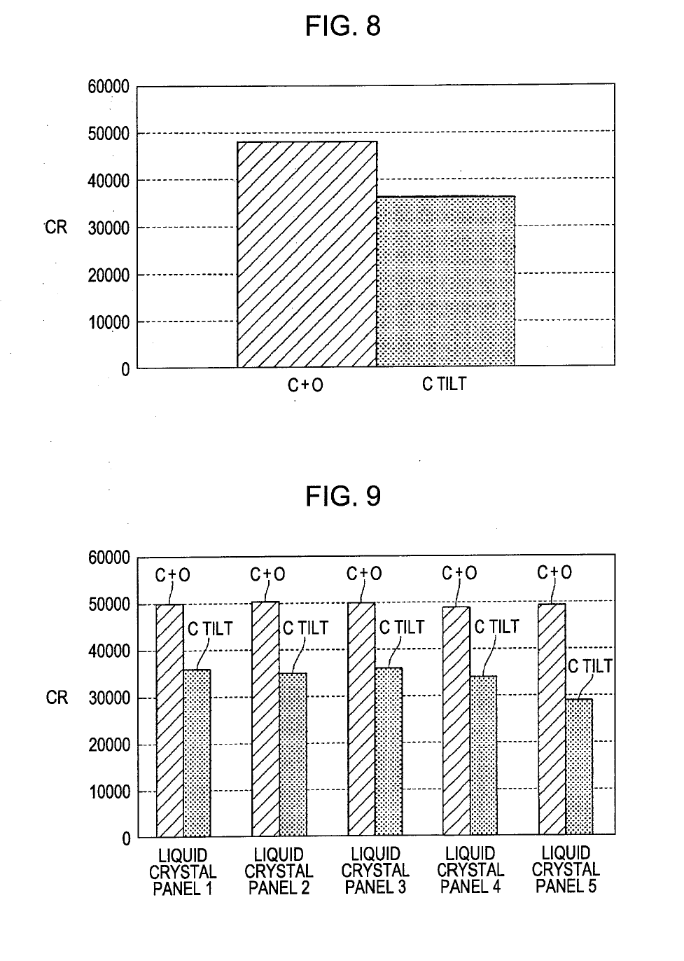

The actual contrast measurement result is shown in FIG. 8.

According to the result shown in FIG. 8, the reflective light modulation device 8 according to the embodiment shown as “C+O” was confirmed to have improved contrast compared to the related art shown as “C tilt”.

### EXPERIMENT EXAMPLE 2

Next, as the configuration of the reflective light modulation device 8 shown in FIG. 3A, the contrast was measured in a similar manner to the experiment example 1 using the phase difference compensation plate 60 with optimal conditions. Here, as the C plate 62 of the phase difference compensation plate 60, a C plate where Rth=240 nm was used, and as the O plate 63, an O plate where Re=10 nm and phase difference ratio=2 was used.

In addition; the same as in the experiment example 1 was used as the comparative example.

Additionally, in the experiment example 2, five liquid crystal panels 80 with the same configuration were prepared and the contrast of each was examined.

The actual contrast measurement result is shown in FIG. 9.

According to the result shown in FIG. 9, the reflective light modulation device 8 according to the embodiment shown as “C+O” was confirmed to have improved contrast with regard to all five liquid crystal panels compared to the related art shown as “C tilt”.

### EXPERIMENT EXAMPLE 3

Next, the relationship of the arrangement of the C plate 62 and the O plate 63 with regard to the liquid crystal panel 80 and the tilt direction of the columns 63a of the O plate 63 in that case was examined.

First, as the arrangement relationship of the liquid crystal panel 80 and the phase difference compensation plate 60, the C plate 62 was positioned in front of the liquid crystal panel 80 (an outer side of the opposing substrate 81) and the O plate 63 was positioned in front of the C plate 62 (side opposite to the liquid crystal panel 80). Accordingly, the path of light is O plate→C plate→liquid crystals→C plate→O plate.

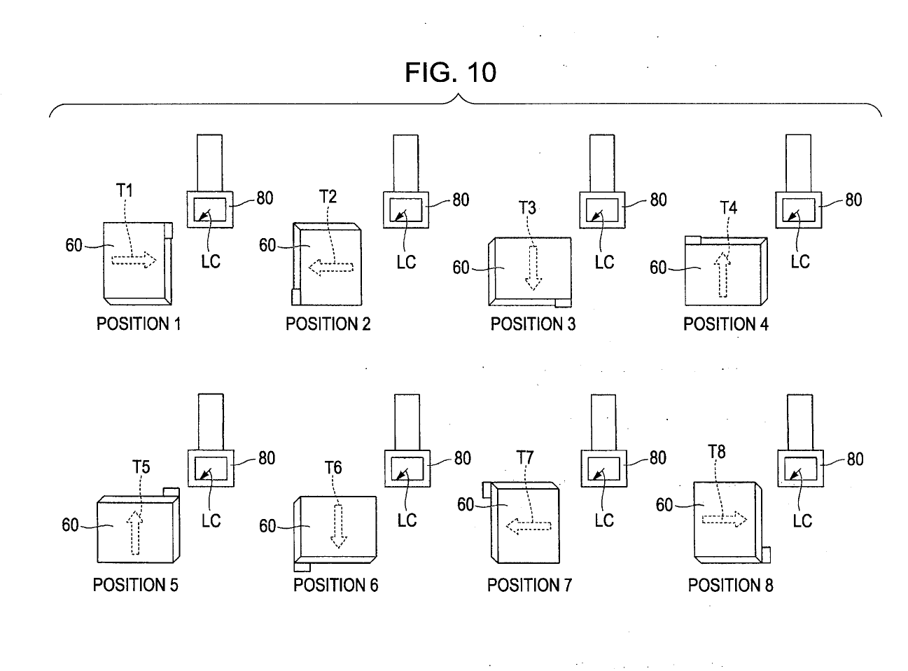

Additionally, in regard to the liquid crystal panel 80, the tilt direction of the liquid crystal molecules 89 was arranged to be a direction shown by a solid-line arrow LC in FIG. 10.

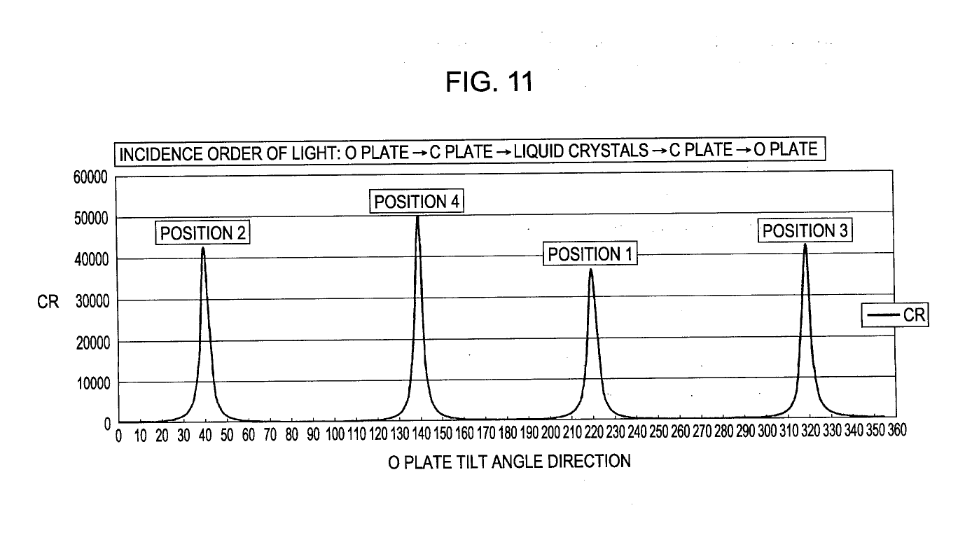

As opposed to this, the contrast properties of the O plate 63 of the phase difference compensation plate 60 were examined by rotating the tilt direction of the columns 63a from 0 degrees to 360 degrees in a clockwise direction with regard to the tilt direction of the liquid crystal molecules 89. That is, the contrast properties were examined by sequentially changing (rotating) the tilt direction of the columns 63a of the O plate 63 in a direction shown by the dashed-line arrows T2, T4, T1, and T3 in FIG. 10 viewed from an outer surface side of the phase difference compensation plate 60 (side opposite to the liquid crystal panel 80). The obtained result is shown in FIG. 11.

Due to the result shown in FIG. 11, four peaks appeared between 0 degrees and 360 degrees. Out of the peaks, it was found that the highest contrast ratio was obtained at a position of 140 degrees shown as position 4 (position of typically 135 degrees in a clockwise direction).

In addition, it was found that the positions (angle settings) in the directions corresponding to the portions where the contrast properties were low in between the peaks were not possible as positions for compensating phase difference.

Next, as the arrangement relationship of the liquid crystal panel 80 and the phase difference compensation plate 60, the O plate 63 was positioned in front of the liquid crystal panel 80 (an outer side of the opposing substrate 81) and the C plate 62 was positioned in front of the O plate 63 (side opposite to the liquid crystal panel 80). Accordingly, the path of light is C plate→O plate→liquid crystals→O plate→C plate.

Additionally, in regard to the liquid crystal panel 80, the tilt direction of the liquid crystal molecules 89 was arranged to be a direction shown by the solid-line arrow LC in FIG. 10.

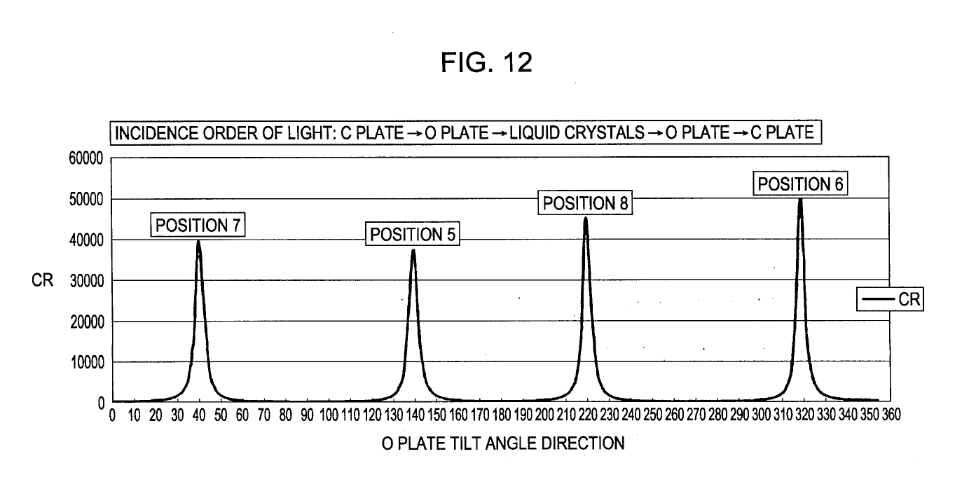

As opposed to this, the contrast properties of the O plate 63 of the phase difference compensation plate 60 were examined by rotating the tilt direction of the columns 63a from 0 degrees to 360 degrees in a clockwise direction with regard to the tilt direction of the liquid crystal molecules 89. That is, the contrast properties were examined by sequentially changing (rotating) the tilt direction of the columns 63a of the O plate 63 in a direction shown by the dashed-line arrows T7, T5, T8, and T6 in FIG. 10 viewed from an outer surface side of the phase difference compensation plate 60 (side opposite to the liquid crystal panel 80). The obtained result is shown in FIG. 12.

Due to the result shown in FIG. 12, four peaks appeared between 0 degrees and 360 degrees. Out of the peaks, it was found that the highest contrast ratio was obtained at a position of 320 degrees shown as position 6 (position of typically 45 degrees in a counterclockwise direction).

In addition, also in this example, it was found that the positions (angle settings) in the directions corresponding to the portions where the contrast properties were low in between the peaks were not possible as positions for compensating phase difference.

### EXPERIMENT EXAMPLE 4

With regard to the arrangement relationship of the liquid crystal panel 80 and the phase difference compensation plate 60, eight types of such relationships shown in FIG. 10 were produced based on the results in the experiment example 3.

The arrangement with position 1 to position 4 shown in FIG. 10 is an arrangement corresponding to each of the four peaks shown as position 1 to position 4 in FIG. 11, and the C plate 62 is positioned in front of the liquid crystal panel 80 (an outer side of the opposing substrate 81) and the O plate 63 was positioned in front of the C plate 62 (side opposite to the liquid crystal panel 80). Accordingly, the path of light is O plate→C plate→liquid crystals→C plate→O plate.

Additionally, in regard to the liquid crystal panel 80, the tilt direction of the liquid crystal molecules 89 was arranged to be a direction shown by the solid-line arrow LC in FIG. 10.

As opposed to this, in the O plate 63 of the phase difference compensation plate 60, the tilt direction of the columns 63a was arranged to be a direction shown by the dashed-line arrows T1 to T4 in FIG. 10 viewed from an outer surface side of the phase difference compensation plate 60 (side opposite to the liquid crystal panel 80). That is, in position 1, the tilt direction (arrow T1) of the columns 63a of the O plate 63 was set to be 225 degrees in a clockwise direction (135 degrees in a counterclockwise direction) with regard to the tilt direction (arrow LC) of the liquid crystal molecules 89. In the same manner, in position 2, it was set to be 45 degrees in a clockwise direction, in position 3, it was set to be 315 degrees in a clockwise direction (45 degrees in a counterclockwise direction), and in position 4, it was set to be 135 degrees in a clockwise direction.

The arrangement with position 5 to position 8 was an arrangement corresponding to each of the four peaks shown as position 5 to position 8 in FIG. 12, and the O plate 63 was positioned in front of the liquid crystal panel 80 (an outer side of the opposing substrate 81.) and the C plate 62 was positioned in front of the O plate 63 (side opposite to the liquid crystal panel 80). Accordingly, the path of light is C plate→O plate→liquid crystals→O plate→C plate.

Additionally, in regard to the liquid crystal panel 80, the tilt direction of the liquid crystal molecules 89 was arranged to be a direction shown by the solid-line arrow LC in FIG. 10 in the same manner as the case of position 1 to position 4.

As opposed to this, in the O plate 63 of the phase difference compensation plate 60, the tilt direction of the columns 63a was arranged to be a direction shown by the dashed-line arrows T5 to T8 in FIG. 10 viewed from an outer surface side of the phase difference compensation plate 60 (side opposite to the liquid crystal panel 80). That is, in position 5, the tilt direction (arrow T5) of the columns 63a of the O plate 63 was set to be 135 degrees in a clockwise direction with regard to the tilt direction (arrow LC) of the liquid crystal molecules 89. In the same manner, in position 6, it was set to be 315 degrees in a clockwise direction (45 degrees in a counterclockwise direction), in position 7, it was set to be 45 degrees in a clockwise direction, and in position 8, it was set to be 225 degrees in a clockwise direction (135 degrees in a counterclockwise direction).

The contrast of the reflective light modulation device was examined with each of these arrangements.

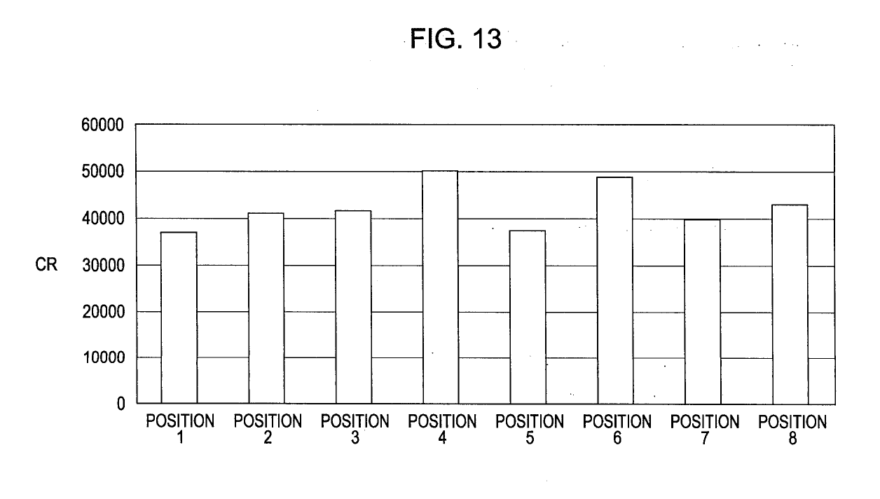

The actual contrast measurement result is shown in FIG. 13.

Due to the result shown in FIG. 13, position 4 and position 6 were confirmed to have high contrast compared to the other positions. Accordingly, in the invention, position 4 and position 6 are adopted and the liquid crystal device is configured.

In addition, in a case when the slow axis of the liquid crystals differs by 90 degrees, that is, even in L liquid crystals and R liquid crystals, it was confirmed that high contrast is obtained at position 4 and position 6 shown in FIG. 10 compared to other positions.

In the liquid crystal device formed from the reflective light modulation device such as this, it is possible to obtain a sufficient compensation effect without tilting the C plate using the phase difference compensation plate 60 formed from the C plate 62 and the O plate 63 arranged in parallel with regard to the liquid crystal panel 80, and accordingly, it is possible to achieve high contrast by making the brightness during black display be sufficiently small.

Additionally, in the liquid crystal device where the WG-PBS 93 (93a, 93b and 93c) is added to the reflective light modulation device, the phase difference compensation with in-plane rotation is performed even for the WG-PBS 93 (93a) with regard to light reflected by the liquid crystal panel 80 and transmitted by the phase difference compensation plate 60.

Additionally, since the liquid crystal projector 1 (projection display device) provided with the liquid crystal device is able to be achieved and the liquid crystal device is able to achieve high contrast, it is possible to achieve high contrast in the liquid crystal projector 1 itself.

In addition, the invention is not limited to the embodiments but various modifications can be made based on design requirements and the like within the range which does not depart from the main points of the invention. For example, in the embodiments described above, as the phase difference compensation plate 60, a configuration as shown in FIG. 5A is used. However, as shown in FIG. 5B, the phase difference compensation plate 60 may be formed by a C plate (negative C plate) 62A being formed on one surface of the substrate 61, and on the other surface, a C plate (negative C plate) 62B and the O plate 63 being laminated in this order.

In this case, the C plate 62A and the C plate 62B are each formed with regard to the substrate 61 so that the optical properties of the combination of the C plate (negative C plate) 62A and the C plate (negative C plate) 62B is the same as the C plate 62 shown in FIG. 5A. According to this, the C plate 62A and the C plate 62B are able to be deemed as the one sheet of the C plate 62. Accordingly, with regard to the liquid crystal panel 80, by arranging the C plate 62 (the C plate 62A and the C plate 62B) and the O plate 63 in the predetermined order described previously and by setting the tilt direction of the columns 63a of the O plate 63 in the predetermined direction (T4 and T6) described previously with regard to the tilt direction LC of the liquid crystal molecules 89, it is possible to configure the liquid crystal device according to the invention.

Additionally, although not shown, the C plate and the O plate of FIG. 5B may be interchanged, and the phase difference compensation plate 60 may be formed by the C plate and the O plate being laminated in this order on one surface of the substrate 61, and the O plate being formed on the other surface. Also in this case, the optical properties of the combination of the two O plates interposing the substrate 61 is set to be the same as the O plate 63 shown in FIG. 5A.

Furthermore, the phase difference compensation plate 60 may be formed by the C plate 62 being formed on a substrate 61A and the O plate 63 being formed on a substrate 61B as shown in FIG. 5C instead of the phase difference compensation plate where the C plate 62 and the O plate 63 being formed with regard to the one sheet of the substrate 61 and integrated together. That is, the combination of these elements may be used as the phase difference compensation plate 60.

Also in the case when the phase difference compensation plate formed from these elements is used, with regard to the liquid crystal panel 80, by arranging the C plate 62 and the O plate 63 in the predetermined order described previously and by setting the tilt direction of the columns 63a of the O plate 63 in the predetermined direction (T4 and T6) described previously with regard to the tilt direction LC of the liquid crystal molecules 89, it is possible to configure the liquid crystal device according to the invention.

Additionally, in the embodiment, as the polarization beam splitter, the wire grid polarization beam splitter (WG-PBS) is used. However, instead of this, for example, a polarization beam splitter which is formed by two prisms, which have an inclined surface of a rectangular prism coated with a dielectric multilayer having the inclined surfaces thereof attached, may be used.

Also, in the embodiment, an example is described where a reflective light modulation device of a liquid crystal protector 1 is applied as an example of the liquid crystal device according to the embodiment, but the liquid crystal device of the invention is not limited to this. For example, it is possible for a head-mounted display (HMD) or an electronic viewfinder (EVF) which are other liquid crystal devices to be applied with the liquid crystal device of the invention. Additionally, the invention may be applied to a direct view type display such as a display screen of a mobile phone terminal.

The entire disclosure of Japanese Patent Application No. 2010-062093, filed Mar. 18, 2010 is expressly incorporated by reference herein.

What is claimed is:

1. A liquid crystal device comprising:
a liquid crystal panel where a liquid crystal layer having liquid crystals with negative dielectric constant anisotropy is interposed between a first substrate and a second substrate, liquid crystal molecules of the liquid crystal layer are tilted in a predetermined direction with regard to an inner surface of the first substrate and an inner surface of the second substrate, and a reflective layer, which reflects light incident from the first substrate to the first substrate side, is provided in the second substrate;
a C plate provided on an outer side of the first substrate of the liquid crystal panel; and
an O plate provided on the C plate side opposite to the liquid crystal panel,
wherein the O plate is formed by oblique evaporation of an inorganic material and is arranged with regard to the liquid crystal panel so that the tilt direction of columns formed from the inorganic material are typically at 135 degrees in a clockwise direction with regard to the tilt direction of the liquid crystal molecules.

2. A liquid crystal device comprising:
a liquid crystal layer having liquid crystals with negative dielectric constant anisotropy is interposed between a first substrate and a second substrate, liquid crystal molecules of the liquid crystal layer are tilted in a predetermined direction with regard to an inner surface of the first substrate and an inner surface of the second substrate, and a reflective layer, which reflects light incident from the first substrate to the first substrate side, is provided in the second substrate;
an O plate provided on an outer side of the first substrate of the liquid crystal panel; and
a C plate provided on the O plate opposite to the liquid crystal panel,
wherein the O plate is formed by oblique evaporation of an inorganic material and is arranged with regard to the liquid crystal panel so that the tilt direction of columns formed from the inorganic material is typically at 45 degrees in a counterclockwise direction with regard to the tilt direction of the liquid crystal molecules.

3. The liquid crystal device according to claim 1,
wherein the O plate has a front phase difference Re equal to or less than 20 nm and a phase difference ratio is more than 1 and equal to or less than 3, and
the C plate has a thickness-direction phase difference Rth equal to or more than 100 nm and equal to or less than 300 nm.

4. The liquid crystal device according to claim 3,
wherein the O plate has a front phase difference Re of 10 nm and a phase difference ratio of 2, and
the C plate has a thickness-direction phase difference Rth of 240 nm.

5. The liquid crystal device according to claim 1,
wherein a polarization beam splitter is provided on a side of the C plate and the O plate opposite to the liquid crystal panel, and the transmission axis of the polarization beam splitter is arranged with regard to the liquid crystal panel so as to be typically 45 degrees or 135 degrees with regard to a slow axis of the liquid crystal molecules.

6. A projection display device comprising the liquid crystal device according to claim 1 as a light modulator.

7. A projection display device comprising the liquid crystal device according to claim 2 as a light modulator.

8. A projection display device comprising the liquid crystal device according to claim 3 as a light modulator.

9. A projection display device comprising the liquid crystal device according to claim 4 as a light modulator.

10. A projection display device comprising the liquid crystal device according to claim 5 as a light modulator.
